(19) United States
(12) Patent Application Publication
(10) Pub. No.: US 2004/0047103 A1
(43) Pub. Date: Mar. 11, 2004

(54) Device for guarding against electrostatic and electromagnetic disturbances

(76) Inventors: Stephan Schmidt, Augsburg (DE); Wilhelm Neukam, Bobingen (DE)

Correspondence Address: LERNER AND GREENBERG, P.A., POST OFFICE BOX 2480, HOLLYWOOD, FL, 33022-2480, US

(21) Appl. No.: 10/616,113

(22) Filed: Jul. 9, 2003

(30) Foreign Application Priority Data
Jul. 9, 2002 (DE) 102 30 902.7

(51) Int. Cl. H02H 9/06

(52) U.S. Cl. 361/118

(57) ABSTRACT

A configuration for guarding against electrostatic and electromagnetic disturbances of electronic components in a housing, in a transition from a first housing part to a second housing part, which parts are detachably connected to one another, includes corresponding end surfaces of the housing parts fitting closely with one another so that conductive contact occurs between the housing parts on an optimally large surface occurs and so that the end surfaces have at least one corresponding bend.

### BACKGROUND OF THE INVENTION

### Field of the Invention

The invention relates to a device for protecting against electrostatic and electromagnetic disturbances in electrical components in a housing in a junction from the first housing part to another housing part, which are joined in detachable fashion.

Electrostatic charges that are harmful to electronic components originate in nature and in people who work with electronic components and assemblies, as well as in objects that are moved more or less rapidly in the course of production processes. Electrostatic discharges can cause damage to electronic components, such damage frequently being revealed only in later operation. Furthermore, an electromagnetic compatibility must be maintained in devices with electronic components. Particularly in semiconductor components whose clock frequency reaches the gigahertz range, disturbances caused by electromagnetic influences must be observed and avoided for the above-mentioned reason. If an electrical or electronic device has a housing of several parts, leaks with respect to electromagnetic waves emerge at the transitions between the housing parts. Similarly, with respect to electrostatic discharges across these housing parts, a transition impedance can be observed at these transitions between the housing parts, which must be minimized in the sense of a reliable dissipation of the electrostatic charge.

German Patent DE 195 07 846 C1 describes a contact element between a housing base body and a removable sidewall of a personal computer (PC) housing or the like. At least one of the housing parts is formed from a plate or sheet metal, whereby the resilient contact element is formed in one piece from the plate of this housing part and makes conductive contact with the other housing part.

International publication WO 01/39331 A1 also describes a contact element between housing parts. This document further instructs that the contact elements are configured on one of the housing parts at regular intervals.

These measures represent an effective ESD and EMV protection up to a defined frequency range.

In the course of the progressive development of semiconductor elements, their clock rate continuously increases, having already surpassed 1 GHz. For clock rates in this frequency range and above, the wavelengths of the electromagnetic waves are so short that they cannot be reliably shielded by the regular configuration of contact elements alone.

### SUMMARY OF THE INVENTION

It is accordingly an object of the invention to provide a device for guarding against electrostatic and electromagnetic disturbances that overcomes the hereinafore-mentioned disadvantages of the heretofore-known devices of this general type and that provides a shielding mechanism that guarantees a reliable shielding of electromagnetic fields and a reliable dissipation of electrostatic charge even in high frequency ranges given high clock rates.

With the foregoing and other objects in view, in a housing, there is provided, in accordance with the invention, a configuration for protecting against electrostatic and electromagnetic disturbances of electronic components, including at least first and second housing parts detachably connected to one another at a transition, the first and second housing parts each having end surfaces fitting with one another to spread electrical contact on a largest possible surface area therebetween, each of the end surfaces of the first and second housing parts having at least one bend.

A configuration for guarding against electrostatic and electromagnetic disturbances of electronic components is provided in a housing in a transition from a first housing part to a second housing part that are detachably connected to one another, whereby corresponding end surfaces of the housing parts have a close fit with one another so that electrical contact occurs on an optimally large surface between the housing parts and whereby the end surfaces includes at least one corresponding bend.

According to the invention, care is taken not only with regard to a contacting between the housing parts but also that an optimally large contact surface emerges between the housing parts and that an air gap that arises between the end surfaces of the housing parts as a result of production tolerances remains optimally small. The electromagnetic waves that permeate the air gap travel therein until striking a contact between the two end surfaces of the housing parts. Because the contacts between the two housing parts at the end surfaces are of a random nature and 100% contacting at the end surfaces cannot be assumed due to production tolerances, a bend is inventively provided in the two contact surfaces, at which the electromagnetic waves are reflected or refracted. A shielding of electromagnetic fields is also guaranteed given less than 100% contacting. The bends in the two contact surfaces are constructed in correspondence with one another so that a labyrinth is produced in which the electromagnetic waves are reflected and refracted.

In accordance with an added feature of the invention, the end surfaces are form-locking and have profiles with a number of sides at which electrically conductive contact occurs. A form-locking connection is one that connects two elements together due to the shape of the elements themselves, as opposed to a force-locking connection, which locks the elements together by force external to the elements.

In accordance with an additional feature of the invention, what is referred to as a gasket is disposed between the two end surfaces of the housing parts to optimize the production tolerances that are present, particularly, in plate or sheet metal parts with respect to shielding electromagnetic waves and dissipating electrostatic charges. This gasket is of easily formable and electrically conductive material and, thus, guarantees the electrical conduction between the two end surfaces and hinders the path of electromagnetic waves through the labyrinth.

Adding additional bends to the labyrinth can further enhance the shielding of electromagnetic waves. The quality of the shielding naturally increases with each bend.

The invention is not only limited to housing parts that are fabricated from plates but is equally effective in housing parts of solid housing parts made of thicker material, provided they are made of electrically conductive metals. What is critical is that the end surfaces of the housing parts enjoy optimal contact so as to allow conductive contact between the two housing parts, and that the two end surfaces have corresponding bends at which electromagnetic waves refract as in a labyrinth, which stops further propagation.

In accordance with another feature of the invention, particularly with respect to the conductive contacting, contact elements are attached at least to one of the two end surfaces. These contact elements guarantee conductive contact between the two housings parts at predetermined points. It is advantageous to distribute these contact elements over the length of an end surface at regular intervals. The selection of the intervals between the contact elements is, occasionally, dependent on the electromagnetic waves that are to be shielded, that is to say, their wavelengths or clock frequency.

The angle of the bend is of secondary importance to the function of the inventive configuration for shielding electromagnetic fields. But, it is advantageous to construct a 90° angle because, in that way, the end surfaces of the housing parts can be produced more cost-effectively.

In accordance with a further feature of the invention, if one of the housing parts is formed from plate or sheet metal, then it is possible to produce the contact elements from this metal as well, in an advantageous fashion. Among other ways, this can be achieved by stamping a window around the contact element in the production process of the housing part, whereby a link plate that is disposed resiliently in a window of the sheet metal emerges for the contact element. To guarantee that the contact occurs at the free end of the contact element as intended, the contact is attached at this point such that the surface of the contact protrudes beyond the plane of the housing part and points in the direction of the other housing part.

To achieve this, an embossing can be made in the free end of the contact element by stamping. But a number of other possibilities also exist to present a contact point there, for instance, attaching a contact rivet, although, due to the high production costs, this would be disadvantageous as compared to stamping.

The embossing can be accomplished with a simple stamping step and is, thus, advantageous compared to other methods of producing the contact points.

It is also advantageous for the contact element to lie in the same plane as the housing part and its end surface. Thus, only the contact point, itself, protrudes from this plane and, therefore, advantageously preventing contact elements from being “hooked” or bent at adjoining housing parts during the housing part assembly process, which impairs their functioning.

In accordance with yet another feature of the invention, the one of the first and second housing parts having the contact elements has a given thickness and the contact elements each have the given thickness.

In accordance with yet a further feature of the invention, the contact elements are disposed beyond the bend and follow a form of the bend.

In accordance with yet an added feature of the invention, the one of the first and second housing parts having the contact elements has an extent from a given portion through the at least one bend to an end and the contact elements are disposed between the at least one bend and the end and follow a form of the at least one bend.

With the objects of the invention in view, in a housing, there is also provided a configuration for protecting against electrostatic and electromagnetic disturbances of electronic components, including at least first and second housing parts detachably connected to one another at a transition, the first and second housing parts each having end surfaces fitting with one another to spread electrical contact on substantially all of a surface area therebetween the end surfaces, each of the end surfaces of the first and second housing parts having at least one bend, the end surfaces being form-locking and having profiles with at least two sides at which electrically conductive contact occurs.

Other features that are considered as characteristic for the invention are set forth in the appended claims.

Although the invention is illustrated and described herein as embodied in a device for guarding against electrostatic and electromagnetic disturbances, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a fragmentary, perspective view of shielding according to the invention at a transition between two adjoining sheet metal housing parts;

FIG. 2 is a fragmentary, perspective view of shielding according to the invention at a transition between two adjoining housing parts with a gasket;

FIG. 3 is a fragmentary, perspective view of shielding according to the invention at a transition between two housing parts with more than one bend;

FIG. 4 is a fragmentary, perspective view of a preferred embodiment of shielding according to the invention with two adjoining sheet metal housing parts with two bends and contact elements;

FIG. 5 is a fragmentary, cross-sectional view of a contact element of FIG. 4 along section line V-V in FIG. 4;

FIG. 6 is a fragmentary, perspective view of shielding according to the invention at a transition between two housing parts that are not made of sheet metal.

### DESCRIPTION OF THE PREFERRED EMBODIMENTS

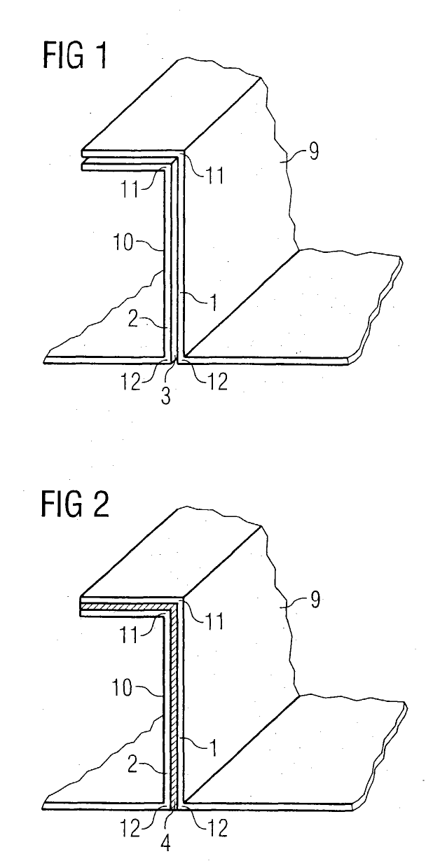

Referring now to the figures of the drawings in detail and first, particularly to FIG. 1 thereof, there is shown a section of a first housing part 1 and a second housing part 2. Because the housing parts are made of sheet metal, a small air gap 3 between the housing parts is difficult if not impossible to avoid due to production tolerances. Electromagnetic fields or waves penetrate the air gap. Absent additional measures, the electromagnetic waves or fields penetrate through the housing at this point. A leak, thus, emerges with respect to electromagnetic waves and fields. To prevent the leak, the invention provides a corresponding bend 11 at the end surfaces of the housing parts 1, 2. The penetrating electromagnetic waves are refracted at the bend 11, preventing further propagation. A right angle is represented for the bends 11 in FIG. 1. The size of the angle is of secondary importance to the function of the invention, namely, the shielding. However, a 90° angle has cost advantages in production. The angle 12 between the end surfaces 9 and 10 and the housing parts 1 and 2 is also represented as a 90° angle. This is a preferred embodiment with respect to the production of the housing parts and the further processing of the housing parts and the assembly. But, other angles are also imaginable and possible at this location. What is important is simply that the angles at the two housing parts correspond to one another, i.e., the end surfaces run parallel to one another and fit closely with one another.

FIG. 2 represents the placement of a gasket 4 at the site of the air gap 3 to reduce the air gap resulting from production tolerances, which causes leaks with respect to the electromagnetic waves and fields. All other variants described in connection with FIG. 1 are also imaginable in the embodiment of FIG. 2.

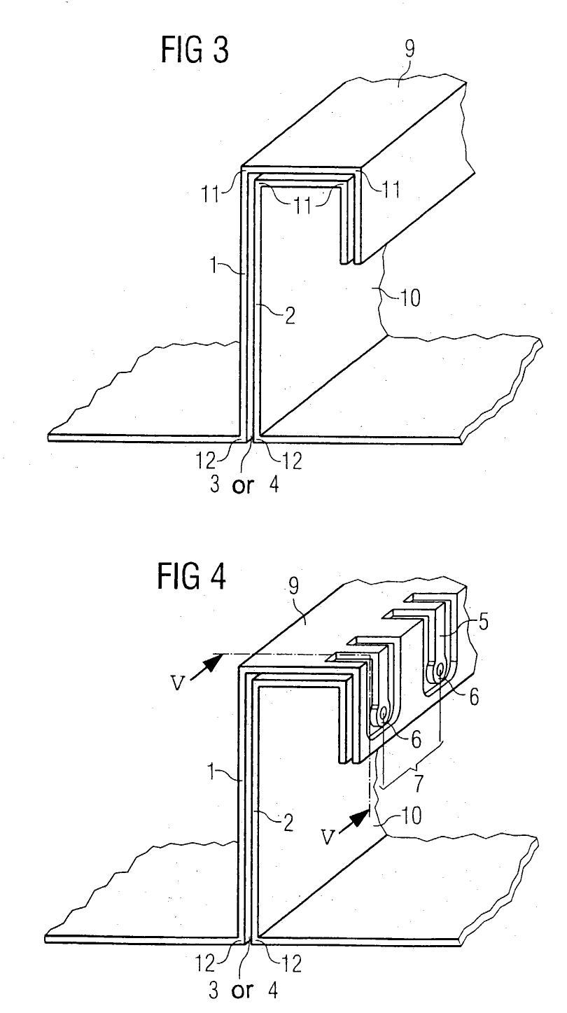

FIG. 3 represents another embodiment of the invention, whereby the labyrinth has been expanded by additional bends 11. The variants described in connection with FIG. 1 are applicable here as well. It is not significant whether or not the angles are 90° angles as represented in this preferred embodiment. Other mutually corresponding angles are also possible. Here, too, a gasket (not illustrated in FIG. 3 but like the gasket 4 of FIG. 2) can be disposed between the two end surfaces 9, 10, which increases the electrical contact between the two end surfaces and further improves the effect of the labyrinth.

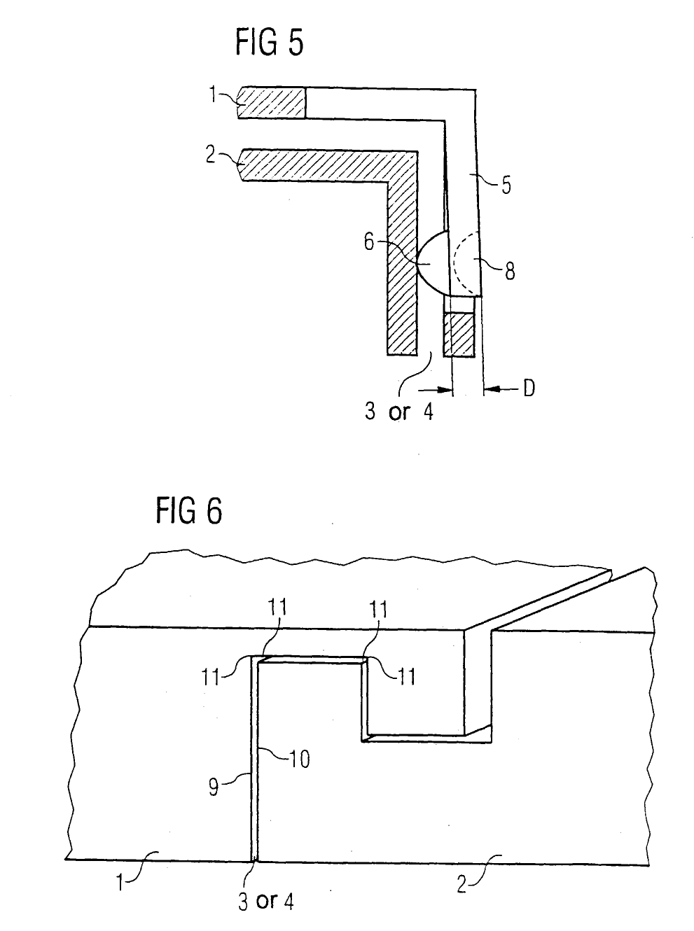

FIG. 4 represents a preferred embodiment that is identical to FIG. 3 in the significant aspects. This embodiment additionally includes contact elements 5 at a housing part. These contact elements 5 are attached to the housing part 1 over the length of the end surfaces 9 at regular intervals. The contact elements are produced from the sheet metal of the housing part by a stamping process. At their free end, the contact elements 5 have an embossing in the direction of the other end surface 10. These embossings 6 guarantee a conductive contact between the two housing parts 1 and 2. The thickness D of the contact elements (see FIG. 5) is, thus, equal to the thickness of the sheet metal of the housing part. There is no further processing of the contact elements besides the punching process and the stamping process for forming the embossings of the contacts.

This production method produces the contact element construction represented in detail in FIG. 5. The contact element 5 includes an embossing 6 that is produced by the stamping 8 in a production process and, thus, has the same thickness D over the whole length of the contact element. It is, thus, guaranteed that, in the idle state of the contact element, no part of the contact element 5 besides the embossing 6 protrudes beyond the plane of the housing part 1. It is also guaranteed that bending at other housing parts cannot occur during housing part assembly, which could lead to the destruction or deformation of the contact element 5.

FIG. 6 represents the inventive shielding at the transition between two housing parts 1 and 2 and their end surfaces 9 and 10, whereby the housing parts 1 and 2 are not made of sheet metal but of solid conductive metal. Here, as in all other exemplifying embodiments, the degree of bends 11 is represented as 90°. However, other angles are also imaginable or possible. In the embodiment of FIG. 6, as well, it is possible and useful to dispose a gasket between the two housing parts, namely between the end surfaces of the two housing parts 9 and 10.

We claim:

1. In a housing, a configuration for protecting against electrostatic and electromagnetic disturbances of electronic components, comprising:
at least first and second housing parts detachably connected to one another at a transition, said first and second housing parts each having end surfaces fitting with one another to spread electrical contact on a largest possible surface area therebetween, each of said end surfaces of said first and second housing parts having at least one bend.

2. The configuration according to claim 1, wherein said first and second housing parts define an air gap therebetween, said air gap being sufficiently small to allow electrical contact to occur between said first and second housing parts over a substantial majority of said surface area.

3. The configuration according to claim 1, wherein said end surfaces are at a right angle to said first and second housing parts.

4. The configuration according to claim 1, wherein said at least one bend is a right angle.

5. The configuration according to claim 1, wherein said end surfaces are form-locking and have profiles with a number of sides at which electrically conductive contact occurs.

6. The configuration according to claim 1, wherein said first and second housing parts define an air gap therebetween and said air gap is filled with a formable and electrically conductive seal.

7. The configuration according to claim 1, wherein at least one of said first and second housing parts is of sheet metal.

8. The configuration according to claim 1, wherein:
said first and second housing parts have end surfaces; and
one of said end surfaces of at least one of said first and second housing parts has contact elements in conductive contact with another of said end surfaces of a respective other one of said first and second housing parts.

9. The configuration according to claim 8, wherein said contact elements are disposed along said end surface at regular intervals.

10. The configuration according to claim 8, wherein said one of said first and second housing parts having said contact elements is of sheet metal.

11. The configuration according to claim 10, wherein at least one of said contact elements is a link plate formed from said sheet metal.

12. The configuration according to claim 10, wherein said contact elements each are link plates formed from said sheet metal.

13. The configuration according to claim 11, wherein said at least one contact element has a free end with a contact-forming embossing in a direction of said other one of said first and second housing parts not having said contact elements.

14. The configuration according to claim 8, wherein at least one of said contact elements is resilient.

15. The configuration according to claim 8, wherein:
said one of said first and second housing parts having said contact elements has a given thickness; and
said contact elements each have said given thickness.

16. The configuration according to claim 8, wherein:
said contact elements each have free ends with contact-forming embossings;
said contact elements lie in a given plane with said one of said first and second housing parts having said contact elements; and
said embossings protrude beyond said given plane in a direction of said other one of said first and second housing parts not having said contact elements.

17. The configuration according to claim 8, wherein said contact elements are disposed beyond said bend and follow a form of said bend.

18. The configuration according to claim 8, wherein:
said one of said first and second housing parts having said contact elements has an extent from a given portion through said at least one bend to an end; and
said contact elements are disposed between said at least one bend and said end and follow a form of said at least one bend.

19. In a housing, a configuration for protecting against electrostatic and electromagnetic disturbances of electronic components, comprising:
at least first and second housing parts detachably connected to one another at a transition, said first and second housing parts each having end surfaces fitting with one another to spread electrical contact on substantially all of a surface area therebetween said end surfaces, each of said end surfaces of said first and second housing parts having at least one bend, said end surfaces being form-locking and having profiles with at least two sides at which electrically conductive contact occurs.

20. The configuration according to claim 19, wherein:
said first and second housing parts have end surfaces; and
one of said end surfaces of at least one of said first and second housing parts has contact elements in conductive contact with another of said end surfaces of a respective other one of said first and second housing parts.

21. The configuration according to claim 20, wherein:
said one of said first and second housing parts having said contact elements has a given thickness; and
said contact elements each have said given thickness.

22. The configuration according to claim 20, wherein:
said contact elements each have free ends with contact-forming embossings;
said contact elements lie in a given plane with said one of said first and second housing parts having said contact elements; and
said embossings protrude beyond said given plane in a direction of said other one of said first and second housing parts not having said contact elements.
